(19) United States
(12) Patent Application Publication
(10) Pub. No.: US 2003/0061358 A1
(43) Pub. Date: Mar. 27, 2003

(54) Method and system for presenting charge related data on a worldwide basis through a network

(76) Inventors: Yolande Piazza, Castle Rock, CO (US); Bridget Kornder, Littleton, CO (US); Doyle Boyd, Littleton, CO (US); Neil Morton, Englewood, CO (US); Norma Love, Coniter, CO (US)

Correspondence Address: KILPATRICK STOCKTON LLP, 607 14TH STREET, N.W., SUITE 900, WASHINGTON, DC, 20005, US

(21) Appl. No.: 10/229,113

(22) Filed: Aug. 28, 2002

Related U.S. Application Data
(60) Provisional application No. 60/315,045, filed on Aug. 28, 2001.

(51) Int. Cl. G06F 15/16

(52) U.S. Cl. 709/227

(57) ABSTRACT

A system is described herein for capturing, viewing, and reporting charge related data on a worldwide basis over a network. This system and corresponding method allow Users to track all aspects of their charged spending through global and local management information. The system allows Users to manage their Organization's charge related data from any location having network (e.g., Internet) access. The system offers analysis tools and reporting capabilities for analyzing and viewing data.

### CROSS-REFERENCE TO RELATED APPLICATIONS

The current application claims priority to and incorporates by reference in its entirety, Provisional Patent Application Serial No. 60/315,045 filed Aug. 28, 2001 and identically titled, “Method and System for Presenting Charge Related Data on a Worldwide Basis Through a Network.”

### BACKGROUND OF THE INVENTION

1. Field of the Invention

The subject matter of the current invention is directed generally to a system and method for providing electronic charge card data to Users. More particularly the subject matter of the current invention is directed to a system and method for providing a User with charge-related data over a network via a User-friendly interface.

2. Description of the Related Art

Current platforms for presenting, charge related (e.g., travel and entertainment) data include stand-alone desktop and client/server, both of which require the sponsoring entity to deliver software and data to Users on an ongoing basis. This requires significant resources for software support/maintenance and manual data distribution. The current distribution system of burning a CD-ROM and mailing it to the User is no longer appropriate. Data delivery is too slow and labor intensive for both the sponsoring entity and the Users. Some Users must store huge data files that are no longer manageable. Furthermore, the time-to-market for new reports and system enhancements is too slow and cumbersome. Further, current platform configurations consist of two disparate database technologies, such as Microsoft's FoxPro and Oracle. Multiple disparate databases result in inconsistencies and duplicate efforts stemming from the need for different skill sets within a limited number of internal staff. This results in higher costs, lower levels of quality and slower time to market. There is a need in the art for a single database platform accessible through a network, to address these issues.

### SUMMARY OF THE INVENTION

According to an embodiment of the present invention, a system is described for capturing, viewing, and reporting charge related data on a worldwide basis over a network. This system and corresponding method allow Users to track all aspects of their charged spending through global and local management information. The system allows Users to manage their Organization's charge related data from any location having network (e.g., Internet) access. The system offers analysis tools and reporting capabilities for analyzing and viewing data.

In an embodiment of the present invention, multiple databases are integrated into one centralized data warehouse (hereinafter “CDW”) incorporating both domestic and international data, allowing for migration from a thick desktop application to a network-enabled thin client application.

In a further embodiment of the present invention, the CDW is backed up on a routine basis, e.g., nightly. Further, a separate fail over/recovery plan using software, hardware, or a combination thereof is used to facilitate processes and procedures for recovering from down time experience by the CDW.

In still further embodiments of the present invention, system parameters include development using the English language, with translation capabilities for Users requesting that the system be distribute in an alternative language. In a first embodiment, the Users are responsible for providing the translation of the item fields, help text, and interface. In a separate embodiment, the User need only identify the User's language of choice and the translator will translate all fields in the system accordingly.

In certain embodiments of the present invention, the system parameters facilitate, inter alia, the following capabilities and results: communicate on the User's selected terms; generate colored graphs and reports that show trends or highlight key facts; track individual account activity, including domestic and internationally-issued charge cards and automated teller machine (hereafter “ATM”) withdrawals; identify accounts with past due balances, or prepare lists of accounts according to User specification; track spending by the User Organization's parent/owner, company, division, office location or department; take control of travel and entertainment (hereafter “T&E”) spending; determine which divisions of the User's Organization are in compliance with T&E policy; compare trends in domestic T&E spending to parallels in international spending; serve up quick answers to high-level management inquiries about spending, vendor relations and account compliance; react quickly to opportunities; try out “what-if?”0 scenarios using high-performance data handling; eliminate the time and expense of paper reports; identify major T&E vendors; show savings that might result from preferred vendor relationships or strategic alliances; export a report to software applications such as Word, Lotus or Excel so that data can be incorporated into other presentations or integrated with data from other sources for additional analysis; define hierarchical levels that reflect a User's Organizational structure, for example, instead of “account” or “summary”, the User can select “employee” or “department.”

The current invention solves the problems of the prior art by providing a network-based application and a more manageable and efficient data access method in order to simplify the charge-related data management process.

According to a first embodiment of the present invention, described herein is a method for administering a charge-related data presentation system for presenting charge-related data The method comprises: establishing within the presentation system a first set of parameters for the presentation of charge-related data, wherein the first set of parameters includes instructions for permitting access to the presentation system and the charge-related data; accessing the presentation system according to the first set of parameters; establishing a second set of parameters for the presentation of charge-related data; and establishing a third set of parameters for the reporting of charge-related data, wherein the first set of parameters is established by a first entity and the second and third sets of parameters are established by a second entity.

According to a second embodiment of the present invention, described herein is a method for presenting charge-related data to multiple related entities. The method comprises: establishing a predetermined hierarchical relationship among the multiple related entities; accessing the charge-related data within a network-based data presentation system according to the predetermined hierarchical relationship, wherein a first entity of the multiple related entities that is highest in the predetermined hierarchical relationship, determines access and presentation abilities for the remaining entities of the multiple related entities; and

presenting charge-related data to the multiple related entities in accordance with the access and presentation abilities determined by the first entity in a report.

According to a third embodiment of the present invention, described herein is a method for capturing, viewing, and reporting of charge-related data over a network. The method comprises: receiving first charge-related data having a first currency; receiving second charge-related data having a second currency; storing the first and second charge-related data in a centralized database; receiving a request to access the centralized database and obtain a report on the first and second charge-related data; prompting control settings for the request, wherein the control settings include: a) a currency type selection to identify the type of currency to be used for the report; and b) a preferred vendors selection to identify vendors that are preferred to be associated with the first or second charge-related data; receiving a selection of each of the control settings; and providing the report based on at least one of the selected control settings,

wherein the first charge-related data is derived from a charged expense incurred by a first entity, and the second charge-related data is derived from a charged expense incurred by a second entity; and wherein the step of providing the report further comprises: a) using the selected currency type for the report when the first and second entities are different; and b) using the first or second currency for the report when the first and second entities are the same.

### BRIEF DESCRIPTION OF THE DRAWINGS

In the Figures:

FIG. 1 shows a system architecture configuration according to an embodiment of the present invention; and

FIG. 2 shows a flowchart depicting a method for utilizing a system of the present invention.

### DETAILED DESCRIPTION OF THE PREFERRED EMBODIMENTS

According to an embodiment of the present invention, a customer sets parameters within a network-based charge-related data system (hereafter “system”) prior to access thereto by any individual User. The network-based system is administered by a system administrator, wherein the system administrator may be part of the entity offering the system for use by the customers. In a specific example, the entity offering the system is the entity with whom the company has established a credit relationship, e.g., Diners Club. In a preferred embodiment, the customer is a Corporation or company (hereafter “Corporation”), constituted by one or more Organizations (hereafter “Organization”). The individual User (hereafter “User”) is affiliated with one or more of the Organizations comprising the corporation in some respect. Further, each Organization may represent or be comprised of multiple subdivisions, departments, franchises and/or affiliates, each of which may have a separate charge account or accounts. The terms Corporation, company, Organization and User are in no way meant to be limiting, but instead are used in the examples to show that there is a hierarchical structure to the relationships between entities having accounts. The network-based system is implemented through server and database configurations wherein the charge-related data can be entered, selected, and viewed via conventional web browser technology, e.g., Microsoft Internet Explorer, Netscape. Web pages are constructed using known languages, such as, hypertext mark-up language (hereinafter “HTML”), active server pages (“ASP”), Javascript and the like.

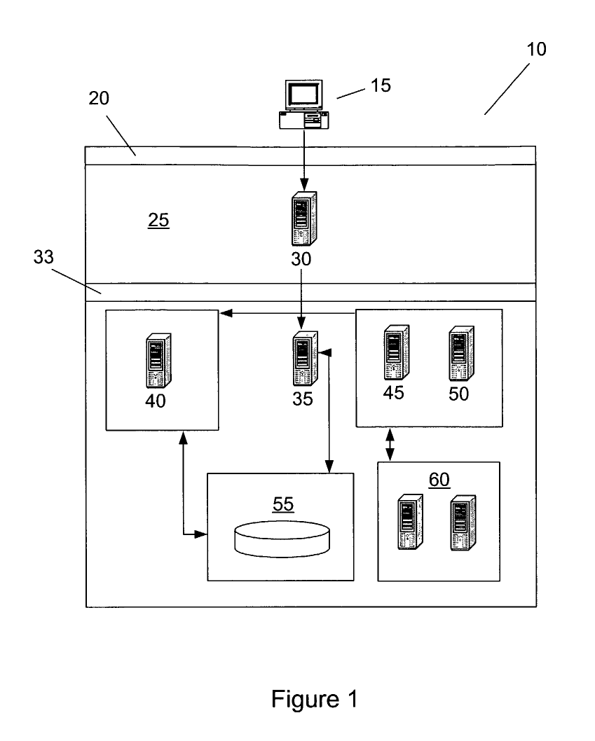

More particularly, according to a preferred embodiment of the present invention, the system includes at least one of each of the following components: relational database server for persistent storage of application data; Internet web server for serving web pages to browsers on the Internet; Info APS (“automated process scheduler”) application server, all Users must connect to an Info APS in order to gain access to tools and information; Info server for processing scheduled jobs such as reports, report packages, queries, programs or OLAP (“Online Analytical Processing”) cubes for providing analysis of stored data; domain controller for housing the security account database; COM+host (COM=Component Object Module); and a report and a storage file server for report output storage. Referring to FIG. 1, in a 0preferred embodiment, the components are arranged according to the depicted architecture 10. The User processor 15, i.e., personal computer, accesses at least one Internet web server 30 through the Internet firewall 20 within the demilitarized zone (“DMZ”) 25. At least one Internet web server 30 connects to at least one file server 35 through an application firewall 33. File server 35 is connected to application database/centralized data warehouse (“CDW”) 55 which communicates with at least one application server 40. At least one application server 40 communicates with an Info APS server 45 and a system database SQL (“structured query language”) server 50 which in turn communicate with at least one domain controller server 60. One skilled in the art recognizes the alternative architecture configurations that fall within the scope of the present invention as described herein.

In a preferred embodiment of the present invention, the system administrator establishes and maintains the CDW which includes, among other things, look-up tables and distribution profiles for multiple customers. The CDW may either be updated through scheduled loading from multiple other databases and servers or alternatively, may have information directly loaded thereto on a real-time basis. In either case, Users may run an initial check through the system to determine if and when data has been uploaded for a particular Organization. This check may be run prior to running reports (described below) so as to ascertain the benefit of running new reports, i.e., if there is no new data, then there is no need to run a new report. In at least one embodiment of the present invention, the need to run checks for uploaded Organization information prior to running reports is unnecessary since the system automatically runs a report upon receipt of new organization information. This feature may be selected by a User through the report scheduler described below.

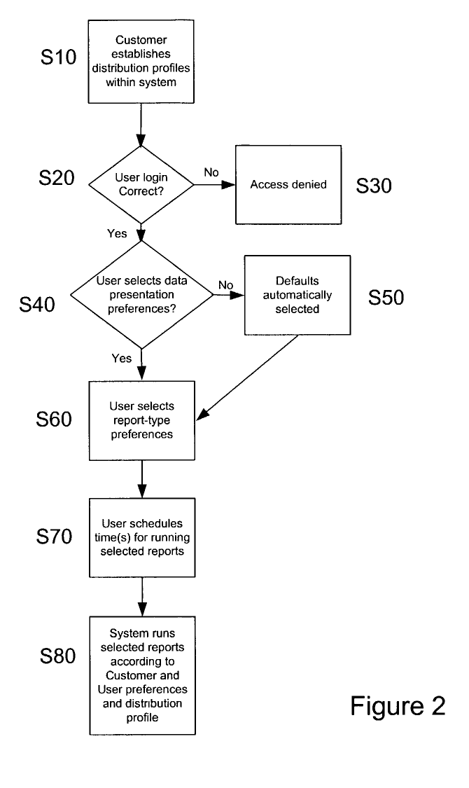

Referring to FIG. 2, the overall method of the system, according to the preferred embodiment of the present invention includes the following steps. A customer establishes preferences and distribution profiles within the system, including the parameters for User access S10. A User attempts to access the system using a pre-established User Identification (hereinafter “User ID”) and Password and the system queries internally, “is this User login correct?” S20, if no, access to further information on the system is denied S30. If the user has entered the correct access information, the User is allowed access to the application whereby they establish their data presentation preferences S40. Should the user elect not to specifically elect data presentation preferences, the default presentation preferences are automatically instituted S50. Next, the user selects report-type preferences S60. As discussed further below, the User may also use a report scheduler in order to schedule a particular frequency for running particular reports S70. Finally, the system runs the selected reports according to customer and User selected preferences and the customer established distribution profiles S80. Each of these steps, including sub steps not specifically referenced in FIG. 2, is described below in detail.

In a preferred embodiment of the present invention, each Customer provides certain hierarchical information and parameter information prior to implementation of the system. This hierarchical and parameter information defines, to a certain extent, the data accessibility of individual Users. Each user sets their own parameter information once they enter the application. The User is able to select particular parameters to suit individual needs.

After the Customer has set the initial parameters, designated Users enter the system using a pre-established User ID and Password. The User ID and Password are established through a setup process whereby the User completes a transmittal form. Each time the User attempts to enter the system, the User is prompted for his/her User ID and Password. Each individual User ID is then associated with an Organization ID or Customer ID (hereinafter “Customer ID”). The Customer ID identifies the corporate Customer as opposes to the individual User. Through the Customer ID, the individual User is associated with the particular Customer and the Customer's established distribution profile. The individual User IDs and Passwords are linked to one or more Organizational/distribution profiles in a data access distribution system (hereinafter “DADS”) which is an internal system that is used for customer information as it pertains to the application. DADS is maintained by the system administrator and is part of the organizing entity. DADS contains profile information for system Users such as User names and passwords and outlines exactly what data the user has access to through the use of assigned Customer IDs. Each individual User must have a User ID and unique password Once a User enters their User ID, the User has the option to save it for automatic detection with subsequent logins without having to re-enter this information. The User ID and password are encrypted when stored. Further, Users have the ability to change their passwords.

As discussed above, for each User, the system and method of the current invention allows for different control settings. The system prompts the User after the User's initial login to complete the User Settings prior to being able to create or request any reports, etc . . . User settings provide Users with the ability to configure their User-defined reporting defaults to meet their specific needs. Alternatively, the User need not affirmatively select some or all settings as the system will use predetermined defaults if none are specifically selected. The User settings differ depending on the User distribution profile previously assigned to the User according to the Corporation hierarchy. As explained in detail below, the User distribution profile dictates, inter alia, the data accessibility given to each individual User. Certain Users within a Corporation or Organization are privy to more or different data than other Users as dictated by the Corporation.

In an embodiment of the present invention, as an initial User setting, the Corporate Name will be used in report headings for reports that are run with multiple Organizations. Reports that are run with only one Organization will display the Organization Name held in DADS in the report heading. The process of including the appropriate name in the report heading is automatically detected dependent on the number of Organizations included on the report. When a User defaults the Account Selection to “All” (described further below) and if the User has access to multiple Organizations, the report will include data for more than one Organization and the Corporation Name appears in the report heading.

The User selects the defaults for date and currency formatting. The User is prompted to select a date format from a list of date formats such as: mm/dd/yyyy; dd/mm/yyyy; yyyy/mm/dd; dd.mm.yyyy; yyyy.mm.dd; and dd-mm-yyyy, wherein one of the listed formats may be a default format.

The User may select from list of currency formats such as: X,XXX.XX and X.XXX,XX, wherein one of the listed formats may be a default format.

Further, the User may select a reported currency code to identify the type of reported currency the User wants to appear on their reports when reported currency fields are displayed and/or selected. An example of a currency code includes USD which stands for United States Dollars.

Language versions represent the help text, field item names and the application text. According to can embodiment of the present invention, Users have the ability to select a language code for each language version for inclusion in their User settings. Through the use of the language code selected by the User, the default field item name list, help text and application text will be presented to the User. In the case where the User does not select language codes, default language codes are in place.

Users can select the Fiscal Year Ending Month option (“MM”) in order to align their reports to their fiscal year reporting cycles so as to, for example, most effectively organize data for budgeting purposes. By way of example, a “9” would align a Users data based upon a 10/1/XX-9/30/XX timeframe. The MM field defaults to a blank. If blank, the report will be aligned to the calendar year.

Users have an option to change Item/Field descriptions and sizes. The default item name is displayed based on the language code associated with the User Profile. Any changes to Field/Item name and size for a particular User ID/Customer ID appear in any prompt lists as well as reports. For field selection on reports, only the indicative data fields and User-defined fields for which the User has defined a title are available for display and selection as well as the full list of data items.

Users have an option to establish and maintain regions that are associated with a country for both Organization/Accounts and for Vendors/Transactions. A display lists the selected Country Name, Organization Region, Vendor Region and the original or default region. The Organization Region and Vendor Regions are initially populated with the values present in the original region. Users have the ability to modify the region information present in the Organization Region and the Vendor Region columns, but not the Country Name and the original or default region. The Organization Region is associated with the Country Code as follows: Organization is the country code present in the Organization Profile and Vendor Region is the country code present in the address information associated with the transaction. For transactions in which there is no address information, the country code presented on the Organization Profile is used. The Vendor Region is associated with transactions based on the country code present in the transaction.

The Organization profile shows information for each subdivision, department, franchise or affiliated company of the Corporation that has a separate charge account, and consequently, charge account data, and is located in the same or a different country. The fields of the pre-established Organization Profile are not editable by the Organization or any User once it has been established, with the exception of the Organization Name field. The Organization profile displays, for example, the following fields: Organization Name (Editable Field); Country Code; Country Name; Franchise Code (i.e. “US”); Headquarters (Yes or No); Billed Currency Type (i.e., USD); and Reported Currency Type (e.g., GBP).

The Preferred Vendors function allows Users to assign specified vendors a Preferred status. This is particularly helpful when, for example, the User chooses to run a report for the vendors with whom the Organization has negotiated favorable rates. It is also useful for compliance purposes. Preferred Vendors will always default to “No” or “Non-Preferred” unless the User changes the status through a Preferred Vendor update option. A mechanism is provided for Users to tag User-defined vendors as “Preferred.” Further, a method is provided for Users to set filters for the following fields to generate a list of Vendors that may be marked as Preferred. The same search functions that are available for report data filters (described below) are made available to Users to use as search criteria (i.e. equal, not equal and contain, etc.). For example, a User wants to define all Hilton Hotels in Colorado as Preferred (Vendor Chain=HILTON HOTELS and Vendor State=CO). The following filters are available to Users for Preferred Vendor identification purposes: Preferred/Non-Preferred; Vendor Chains (Merchant Specific Code (“MSC”) Description); Vendor Names; Vendor Cities; Vendor States; and Vendor Country. As with many data filters, the User has the option to display a list of values for each field in which the User is setting criteria. Users can select additional fields for display to provide additional information for Preferred Vendor determination. In addition to the fields listed above, the following fields are also available for display: Vendor Address Line 1; Vendor Address Line 2; Vendor Zip Codes; and Charge Type. In an embodiment of the present invention, the display defaults to at least Vendor Name and Charge type. With the above-described features, Users can identify the Vendors they wish to mark as Preferred or Non-Preferred and update the information on the Preferred/Non-Preferred Vendor record.

Consolidated Vendor Chains (“CVC”) are used to link vendors that are not linked through the Vendor Chain linkage process. For example, Marriott Hotels owns Courtyard by Marriott and Residence Inns. Each of these hotel chains has to be selected to run vendor reports for all Marriotts unless a Consolidated Vendor Chain has been added to link all of the Marriotts. The initial list of CVC codes contains the MSCs which are available to be modified, new codes can be added, or existing codes can be deleted. Users are provided with a form which prompts the User to add a User-defined CVC code and CVC name. Further, Users have the ability to set filters for the following fields to generate a list of Vendors that may be candidates for assignments of a CVC Code and Name. Boolean type search operators are available to Users to search through criteria (i.e. equal, not equal and contains, etc.). The following items are available to Users for CVC: Consolidated Vendor Chain; Vendor Chains; Vendor Name; Vendor Cities; Vendor Country; and Vendor States. As with all data filters, Users have the option to display a list of values for each field in which the User is setting criteria. Users can select from the following additional fields for display to provide additional information for CVC Vendor determination: Vendor Address Line 1; Vendor Address Line 2

Vendor Zip Code; and Charge Type. In an embodiment of the present invention, the display defaults to at least Vendor Name and Charge type. Using the above-described features, Users can identify the Vendors they choose to associate with a CVC Code and Name.

Finally, Account Level Descriptions can also be defined by the Corporation during the initial set-up period. Account Level Description define the hierarchy of how and to whom (i.e., which Users) charge-related data is to be reported throughout the Corporation, including individual Organizations. These descriptions cannot be changed by any individual User. Account Level Descriptions enable Corporations to customize the account level names for the Organization's reports. The account level names appear in the Account Selection field and any fields that are available for report selection that contain the level description as part of the field name. Users are only able to view the levels set up by the Corporation, to which the Users are granted access through their Customer ID/User ID. Different levels, and thus different account information, correspond to different types of Users. A User may represent a single cardholder and have access to very limited account information or a User may be the representative of a group of cardholders and thus have access to more and/or different account information. Further, a User may establish particular groups of cardholders for which various reports are regularly run.

In an embodiment of the present invention, Cardholder Groups provide the User with another level of granularity for the account reports. For example, a Travel Manager may typically run reports based upon cost center. Each time a report is run, exception criteria are set-up to filter out the relevant cardholders. For a routinely run report, the system allows a User to set up Cardholder Groups if this is a routinely run report. The following fields are available to Users as search and reportable items for reporting: Indicative Data Fields 1-6 contain indicative data items that are specific to the customer and refer to specific customer data. For instance, cost center, personnel numbers, ID numbers, etc. The information is captured for the customer and held for their reporting purposes. The indicative data items can be used as data items on reports or as filter items. User-defined Fields differ from Indicative data in that the User defines the item within the application and updates the data via a file import or via a manual process. An example of a file import process would be to import a Human Resources or Payroll file to update cost centers or Employee Numbers, etc. The Cardholder Group set-up process provides for up to 10 User-defined fields (20 characters). Users are able to link User-defined Fields to Cardholder Groups. At least one User-Defined Field can be changed globally for a Cardholder Group. For example, a User may define a User-defined field as “Cost Center” then populate the Cost Center number (“123”) into the field for a number of cardmembers. There is an automated process to populate the User-Defined Cost Center field for all cardmembers rather than having to input for each cardmember. Further, Users are able to filter or report on any and all User-defined Fields.

In an embodiment of the present invention, data permissioning provides a security check to ensure that Users are accessing the correct data. Data Permissioning restricts data access, allowing only access to the Users that have the rights to view their data as defined by their Organization profile and that is accessible through their Customer ID/User ID. Data is permissioned by: account levels as described above; card indicative data (e.g., by cost center); and summary data vs. detail data. In order to facilitate the data permission, each Corporation establishes an Organization account administrator for each Organization. The Organization account administrator has the authority to set up other Users and their associated User permissions. The system facilitator has the ability to and is responsible for the setup of the initial Organization account administrator for each Organization/Corporation. Further security features of the present invention include a Distribution Setup process which displays a warning message and/or requires a Manager override when data for multiple Organizations are included in the same Distribution Profile. In an embodiment of the present invention, the warning message requires a User to acknowledge that the User is including accounts for multiple Organizations within the same Distribution Profile.

In an embodiment of the present invention, charge-related data is available to Users for at least two full fiscal or calendar years. According to an embodiment of the present invention, data for months beyond the at least two full fiscal or calendar years is dropped, with the exception of certain account balance data. For example, account balance billed buckets must be retained for every billing statement (based on statement date) for the entire period of data retention. This account balance data is used for historical delinquencies trending and to enhance certain existing reports.

In an embodiment of the present invention, file status information is displayed for Users so that the Users can obtain information about when files were loaded for each Organization, e.g., division, franchise, or affiliate (hereinafter “franchise”), subject to the Users profile. The display information includes: Franchise Code; Franchise Name; Submission Frequency for each Franchise, e.g. daily, weekly, monthly, etc.; and Date the last file for each Franchise was loaded into the CDW.

In an embodiment of the present invention, data loads into the CDW are completed within a set period of time from receipt, for example, within 24 hours of receiving an input file from a franchise. Security features minimize franchise data integrity exposure such as internal checks to make sure the franchise input file meet specific file formats. If they do not, the system does not load the data. The system administrator contacts the franchise and they are required to either fix or resend the data.

In an embodiment of the present invention, per Corporate Information Security Office (CISO) standards, data delivered via the public Internet is encrypted using 128-bit Secure Socket Layer (SSL) encryption.

In an embodiment of the present invention, User interpretable error messaging is incorporated into the system for guiding Users accordingly.

In an embodiment of the present invention, online help is available to Users via the system and instructions are displayed based on the language code present in the User settings.

In an embodiment of the present invention, the system and corresponding CDW are accessible by many concurrent Users and/or reports being run at the same time. Concurrent Users is defined as concurrent central processing unit (“CPU”) processing. Users enter a queue during concurrent usage without concern for performance failure from a software and/or hardware standpoint.

In an embodiment of the present invention, CDW statistics are maintained and monitored internally by the system administrator in order to gauge and accommodate usage patterns. Internal statistical reports are accessible on a daily basis via a standard browser. The reports are categorized by profile or aggregated for all Organizations and according to the number of hits by report and by report category. CDW monitoring tools provide statistical information to determine and analyze the type of reports that are being run most frequently. Analysis tools provide the system administrator with the information necessary to monitor system and database performance, User access for troubleshooting, tuning, etc.

In an embodiment of the present invention, reporting options are available to Users for construction of User reports. Reporting options are criteria that Users can be prompted for, or can input/change for both standard and User-defined reports. Default entries are defined to avoid User entry for each option. For example, date type default is “Bill Date”. System reports are classified into two categories, standard templates (canned or pre-defined) and User-defined. Standard templates consist of pre-defined items to be displayed in a pre-defined report layout with pre-defined reporting options. Users have the ability to run any of the standard templates by modifying any of the reporting options as defined in the report requirements below. This includes setting data filters for items not displayed on the report. Users can also add or delete items to be displayed in the report. User-defined reports enable Users to build reports through use of basic criteria and select all field/columns to be included in the report. Additionally, Users can modify their reporting options (data filters, etc.) and can define the layout of the criteria (within the column/row-based format). Basic criteria include the options listed below as they apply to the specific report being created. In certain embodiments of the present invention, defaults will be established for the majority of the criteria options and Users will only be prompted for missing information when defaults have not been defined, e.g., date range.

According to an embodiment of the present invention, Users have the choice of selecting from certain date types in defining report parameters. The date types include: Bill Date which is the date billed as presented on each transaction; Transaction Date which is the Transaction Date present on each transaction, and Post Date which is the Posting Date present on each transaction. A default may be set, e.g., Bill Date. The Date Type selection is only required for reports in which transactions will be included.

In an embodiment of the present invention, Users can select a date range by filling in “From” and “To” date fields. In alternative embodiments of the present invention, Users either manually enter a date or select a date range from a prompt list dependent on the data for the franchise. Dates are presented in drop-down list formats with a standard list going back to Jan. 1, 2000. When the User selects the “From” date from the prompt list, the day value defaults to the first day of the month. When the User selects the “To” date from the prompt list, the day value defaults to the last day of the month (for the appropriate year).

In an embodiment of the present invention, the Account Selection option provides Users the ability to run reports for a pre-defined group of accounts. Users are prompted to select from a list of applicable Account Selections, “All Accounts” field is the default. The “All Accounts” field is the default. The prompt list will only display the accounts as defined by the Organization's hierarchy and/or based on User distribution profiles. For example, if a corporation only has 4 levels, the list of available levels to choose from will only include the 4 levels plus Organization. If the default “All Account” field is selected, all account records associated with the User's distribution profile will be included on the report.

In an embodiment of the present invention, Users are provided with an option to select multiple charge types, a single charge type or all charge types. Similarly, there is also a de-select option for one or all previous selections. The charge type selections include, but are not limited to: Airlines, Rail (train), Car Rental, Hotel, Restaurant, Gas/Oil, Taxi/Limousines, Retail, Mail Order, Cash Advance, Telephone Services, Late Fee, Member Fee, Adjustments, Payments, Other, and All.

The Charge Types default selections will be completed for all standard reports. For some or all reports Users will have the option to change the selections. For User-defined reports, the User must select charge types; “All Charge Types” is the default. If the User does not select a charge type(s), the user is prompted them to select charge types for the report being defined.

In an embodiment of the present invention, currency fields are formatted with periods or commas dependent on the User Settings. All Currency fields are right justified on the reports. Decimal placement on reports is based on the currency and decimal placement as defined in the Currency Table, e.g., 0 decimal, 2 position decimal, 3 position decimal.

In an embodiment of the present invention, data filters allows Users to narrow their queries based upon a User-defined set of criteria. The items made available to the User will differ based upon the report being run and the reporting options, such as charge type, selected. For example, Air From-City Code would not be an option if a User does not select the Air charge type. Additionally, if a User defines “Account City=Denver” as a data filter option, Denver will only appear if the franchise has data in “Denver” for Account City. The following operators are available to Users to facilitate data searching and reporting. “Equals” retrieves all exact matches, for example, EQUALS HILTON→HILTON. “Contains” retrieves all occurrences of the alphanumeric text the User enters, disregarding whether or not it is a word, for example, CONTAINS HIL→HILTON, HILLTOP, SHILLINGTON. “Greater Than” retrieves all numeric data greater than the value entered, e.g., for dates. Greater Than returns all dates more recent than the date you enter. For example, GREATER THAN 25.00→26.00, 45.31 and GREATER THAN Feb. 14, 1999→Mar. 10, 1999, Jan. 01, 2000. “Empty” retrieves all records for which the selected field is blank. “Not Empty” retrieves all records for which the selected field contains data. “Less Than Or Equal To” retrieves all numeric data less than or equal to the value you enter. Less Than Or Equal To returns all dates earlier or equal to the date entered. For example, LESS THAN Or Equal To 25.00→21.00, 12.01, 0.75 and LESS THAN Feb. 14, 1999→Feb. 1, 1998, Dec. 14, 1996. “Like” retrieves all near matches such as plural variations and spelling variations. For example, LIKE HILTON→HILTON, HILTONS, HYLTON. “Begins” retrieves all values where the text begins with the entered or selected value. For example, BEGINS SHERATON→SHERATON HOTELS, SHERATON INNS, SHERATON SEASONS HOTEL.

Further to this embodiment, the system provides the ability for Users to display a list of values for the fields on which they choose to set the filter. For example, if the User chooses to set data filters on the Vendor Name, the User must be able to display a list of Vendor Names for transactions for that particular User. All values displayed for Data Filter fields associated with an account or transaction must be limited to the data that is loaded for the Organizations/Distribution Profile to which the User has access.

In an embodiment of the present invention, Users have the ability to print a page, separate from the report, displaying the criteria selected for the report. The following display criteria are displayed on the criteria page if requested by the User when running a report: Date Range, Date Type, Account Selection, Charge Type, Data Filter criteria selected, Fiscal/Calendar Year, Top Vendors, and any additional items Users have a choice to define within a report

In an embodiment of the present invention, when building or modifying a standard report or building a User-defined report, the User is able to view the layout prior to executing the report. Users are able to select the items they want included in the report and the columns in which to include them, such as drag and drop. Further, Users are provided with the ability to easily insert or delete columns and are able to change the field descriptions or report titles within the report layout.

In an embodiment of the present invention, where multiple Organizations are selected to be included in a report, the reported currency is automatically used on Standard Reports. If a single Organization is on the standard report, the billed currency is displayed. This feature of the present invention supports multinational functionality.

In an embodiment of the present invention, Users are provided with the ability to sort on any field included within the report. Ascending (default) or Descending sort options are available. In a particular embodiment, a maximum of 10 levels of sorting is required. Users indicate or mark sort fields on which they choose to suppress repeated values as an option.

In an embodiment of the present invention, the User has the ability to create sub-totals. In order to ensure the integrity of the sub-totaled amounts, sub-totals are created on columns having the same currencies. In an alternative embodiment of the present invention, when an attempt is made to create sub-totals on columns with mixed currencies, a message is displayed advising the User that mixed currencies cannot be totaled. The User selects the sort field(s) on which they want to complete subtotaling. The subtotaling function is specifically tied or associated with the sort field options described above.

In an embodiment of the present invention, Users are able to align their data by Fiscal Year or by Calendar year for all Spend Analysis reports (described below). The User is able create Spend Analysis reports based on either the fiscal year or the calendar year. Fiscal Year alignment is available on an annual, semi-annual or quarterly basis. This is a data filter item, defaults to “Both” (Foreign and Domestic) unless otherwise indicated in the Data Filter (i.e. Transaction Type=Foreign). The data filter for transaction types of Charges and Credits is defaulted to “Both” unless otherwise indicated in the data filter, e.g., transaction type=credits.

The present invention provides Users with an option to drill down from summary data to the detail data.

The present invention provides for prefix searching within prompt lists that have a scroll bar.

The present invention includes the ability to create User-defined data templates, containing pre-defined text and/or charts, which can be pre-populated with data. For example, some Travel Managers send letters to their card members when they are 30, 60, 90 days, etc. past due on their account.

Further to the present invention, the following Summary Statistics options are available to the User: Count, Sum, Average, percent (%) of item, i.e., total amount.

According to the present invention, certain report output is integratable into other programs such as Microsoft Excel and Lotus.

According to embodiments of the present invention, the User may generate both summary and detail reports. Summary reports are defined as reports in which selected fields are summarized or grouped, such as by Vendor Name. On Summary Reports, Users may elect to include one or all of the Summary Statistic information, i.e., specifically count, sum and/or average columns of information. Detail reports are reports in which information is based on individual transactions and is not summarized.

The system and method of the present invention include a User function of report scheduling. The scheduler tool enables a User to run pr print reports at a frequency. The scheduler tool is based on active server pages (ASPs) that are available with, for example, Microsoft Internet Information Server. The ASPs access the appropriate server or servers and ultimately the data warehouse to retrieve scheduling and report information. This function accommodates a single report or multiple reports in a batch mode. An option to schedule “Now”, “One Time” or “Scheduled” is available. The “Now” option automatically triggers a report to be run once the OK button is selected. According to a preferred embodiment of the present invention, upon completion of the report, an email notification can be sent to the User advising completion and availability of the completed report. The User is prompted to select a Day when selecting either the “One Time” or “Scheduled” option. Users are able to select from a calendar or from a Clock. Users selecting “Scheduled” are able to select Daily, Weekly, Monthly or quarterly, semi-annual, or annual. An option is provided for the User to select the a.m./p.m. time or military time formats. Depending on the time format that is selected, the server time is presented to the User in the selected format, including adjustment for the Users local time, e.g., time zone, daylight savings, and format. The report scheduler is able to accommodate multiple scheduled tasks simultaneously. A User may set up different reports to run daily, weekly and monthly and can cancel reports that have been scheduled/requested. When reports have been created and are available for Users, information is provided regarding the size of the file/report to allow Users to make a decision as to when they want to download large/small reports. In formatting the report scheduler, Users are prompted for the following frequencies when scheduling a report to run: monthly (e.g., end of month); bi-monthly; billed month; semi-annually (fiscal and calendar); annually, quarterly fiscal year; quarterly calendar year; weekly and daily. The User may also be prompted for a particular date range and may have the report scheduled to run based on the occurrence of particular events.

The system and method of the current invention allow Users to name a report and include a report description for any modified report or new User-defined report that is being created. Reports being assigned a report name (either a new report or a modified report), can be saved to one of the existing reporting categories or to a pre-established folder, i.e., “My Reports” folder. Users have the option to create and/or save reports in at least one of the following formats using a selection incorporated in the report scheduler: XLS; CSV; HTML; DOC; RTF; WKS; and PDF (Portable Document Format).

According to preferred embodiments of the present invention, report headers display at least the following report header information on the first page of the report: Report Name; “Billed or Reported Currency Amounts in XXX (e.g., USD=U.S. Dollars);” Date Range (When Applicable); Run Date; Page Numbers i.e., Page X of Y. The “Billed or Reported Currency Amounts in XXX” information header varies depending on whether the report is being run to include data for multiple Organizations. If the report is being created for only one Organization, the heading is “Billed Currency Amounts in XXX,” where XXX equals the billed currency code from the Organization Profile. If the report is being created for multiple Organizations, the heading is, “Reported Currency Amounts in XXX”, where XXX equals the Reported Currency Code for the specific User. Other reports include additional information to be included in the heading, such as the Account Inquiry Report.

According to the system and method of the present invention, standard reports are categorized by function and all standard reports are alphabetized in one category. The following paragraphs describe the functional categories and the applicable standard reports. As discussed above, the system and method of the present invention include the ability to switch reports from Summary to Detail reports at the time the report is being requested and setup for processing.

In order to perform a vendor analysis, vendor reports are run and evaluated by, for example, a Corporation's travel manager in order to negotiate preferred vendor rates and expand vendor relationships. According to an embodiment of the present invention, a first general vendor report includes the following options to be selected by the User of: Date Type Selection; Account Selection; Charge Type Selection (Excluding Payments and Adjustments); Data Filter Items; Top Vendors; transaction type; and the option of reporting on either vendor name, Vendor Chain or Consolidated Vendor Chain. The data filter items include, but are not limited to, Consolidated Vendor Chain, Preferred Vendor (Yes/No), Standard Industrial Classification (“SIC”) description Charge Type, Vendor Name, Vendor Chains (MSC Description), Vendor Cities, Vendor States, Vendor Region, and Vendor Country. The top vendors option enables Users to create the report for top vendors based on the monetary amount, count or average. The transaction type may be further limited to domestic, foreign, or both.

Further to the vendor analysis, more specific vendor reports may be run according to the present invention. Reports may be run that reflect the car rental spending totals for each vendor that includes at least vendor name, transaction date and billed amount. Other options selectable by the User include date type selection, date range selection, account selection, charge type selection, and transaction data filter items.

Reports may be run for vendor hotel spending by city including hotel spending by Vendor, according to City and State. Other options that are selectable by the User include date type selection, date range selection, account selection, charge type selection, and transaction data filter items.

Travel management reports may be run by vendor which include Vendor Name and Period count and amount as well as year-to-date (“YTD”) count and amount. Other options that that are selectable by the User include date type selection, date range selection, account selection, charge type selection, and transaction data filter items.

Vendor analysis reports may be run by foreign and/or domestic location which include vendor information for transactions incurred in a foreign or domestic country according to country, city and vendor name along with the billed amount, count and average. Other options that are selectable by the User include date type selection, date range selection, account selection, charge type selection, and transaction data filter items.

Vendor Analysis by Vendor reports may be run for foreign and/or domestic transactions which include information for domestic transactions by charge type, vendor, chain, states, cities and vendor name. Other options are selectable by the User include date type selection, date range selection, account selection, charge type selection, and transaction data filter items.

Reports may be run for a category of other charges. This report provides a list of activity for charges and credits with a charge type of “Other” including the SIC charge type, vendor name and amount, count and average. Other options that are selectable by the User include date type selection, date range selection, account selection, charge type selection, and transaction data filter items.

Restaurant Activity reports may be run and include a list of activity for restaurant transactions by vendor within city and state. Other options that are selectable by the User include date type selection, date range selection, account selection, charge type selection, and transaction data filter items.

Gas/Oil Activity reports may be run and include a summary list of activity for Gas/Oil transactions by Vendor Name within Vendor Chain. Other options that are selectable by the User include date type selection, date range selection, account selection, charge type selection, and transaction data filter items.

Delinquency reports may be run by a User and are primarily used to measure and gauge potential account write-offs. The reports are used differently depending upon the liability of accounts. There will be a known discrepancy between reported currency transaction amounts when summing those same transactions back in time due to the current bill date being used to translate historical delinquency amounts. Additionally, the timing of franchise delivery will affect the accuracy of aging buckets. “Aging buckets” refer to amounts that are delinquent by individual accounts. They are held at pre-defined time frames. The aging bucket tracks accounts that are delinquent by virtue of non-payment and the total of all accounts that are overdue.

Delinquency aging analysis reports provide advance warning for controlling delinquencies. The delinquency aging analysis report separates delinquent card members into two groups 1) those of recent vintage usually needing only a reminder phone call, and 2) past due accounts which may require more attention. This report is produced at a predetermined time each cycle, e.g.,16 days after each bill date, and displays all card members who are still in the 30-days past due category as of that date. In particular embodiments, the report may display all delinquent card members or only card members who are delinquent by a particular amount, e.g., $100 or more. By showing $100 and greater amounts that are in danger of rolling to sixty days, the report enables Corporations focus efforts directly on major delinquency problems. The report also includes a 75-day section that shows all balances in the 60-day or greater categories that are still unpaid as of 75 days after billing. These reports are useful to Corporation who may be obligated to pay a credit card company for monies that are a certain amount past due, e.g.,120 days past due or 150 days past due or 180 days past due. This report allows the Corporation to quickly identify the card members who are delinquent so they can take appropriate action, such as sending notifications/letters via email, etc.

The User may select from the following options in constructing the report: Account selection; indicative data field selection, and entry of number of days delinquent from last bill date. Report criteria and selection enables the User to enter the number of days delinquent for use in selecting accounts for inclusion on the report and using the number of days delinquent, to determine the aged bucket that should be used in the calculation. For example: when 31 through 59 is entered, base the calculation on the 30 day bucket; when 61 through 89 is entered, base the calculation on the 60 day bucket; when 91 through 119 is entered, base the calculation on the 90 day bucket; when 121 through 149 is entered, base the calculation on the 120 day bucket; and when 151 through 179 is entered, base the calculation on the 150 day bucket. By using the number of days past due entered by the User minus the number of days of the appropriate aged bucket as defined above, the report generates the number of days delinquent since the last bill date. Further, using that range, the report selects the “credit” transactions that have been applied to the account during that period of time. Credits include all charge types where the transactions are flagged as credits. Based on any monies in the delinquent buckets, the report applies any payments and credits to the oldest aged buckets first and reduces all monies in the delinquent buckets until the credit amounts have been completely applied. Using the appropriate aged bucket, the report calculates the monies past due since the last bill date on the account. The report ensures that the column titles on the report for the 30+ through 150+ day fields reflect the calculated column titles such as 40 days past due, etc.

The following represents an application of the report calculation steps for a particular example. The User enters 40 days past due. The report performs a calculation using the 30 days past due bucket, wherein the 40 days are deducted from 30 resulting in 10 days for the offset number. This 10 days is added to the last statement date. For example, assuming the statement date is 03/20/XX02, the calculated date will be 03/30/XX02. Any credit transactions posted from 3/21/XX02 through 3/30/XX02 are applied to the delinquent buckets starting with the oldest aged bucket first, i.e. 330, 300, etc. until all the credit monies are exhausted. If all credit monies are applied and a credit amount still exists, the result is a credit balance and the account does not meet the criteria for placement on the delinquency report. After credit transactions have been applied to the delinquency buckets, all accounts and balance information on the report that have monies greater than 0 in the 30/40 day bucket are included in the delinquency aging analysis report. The column headings are reflective of the calculated days past due, so in this example, the 30 day column=40 day column, the 60 day column=70 day column, etc.

A cardholder write-off recovery/account write-off recovery report lists all accounts with write-off balances. The report includes contact addresses and phone numbers to assist in making contact. Report options include account balance data filter items and account selection.

Aging and status analysis reports identify accounts with past due balances, sorted by aging category (30, 60, 90, 120+ days). This report is used to monitor and control account delinquencies. Report options include account balance data filter items and account selection.

Monthly activity and aging (e.g., billed/reported currency) reports include account name and number/franchise code, previous balance, total remittances, total returns, total charges, total amount due and totals for 30, 60 and 90 days past due. Report options include account balance data filter items and account selection.

A 90-day delinquency report identifies card members who have become significantly delinquent on their account. In addition to card member information and indicative data as applicable, this report provides total billed amount, pending adjustment amounts, 90 day balances, 120-210 day balances, 240-330 day balances as well as account status information.

Report options include account balance data filter items and account selection.

Monthly suspension reports, also known as 60 day delinquency reports, list accounts with balances 60+ days past due. Addresses and phone numbers are provided to assist in contacting these individuals. Report options include account balance data filter items and account selection.

Late fee reports list all late fee transactions according to individual card member, description, transaction date and amount. Report options include date type selection, date range selection, charge type selection, account balance data filter items and account selection.

The system and method of the present invention also provides the User with a variety of types of compliance reports. A cash advance exception report provides a list of all cash advances and/or allows a User to set up criteria to provide a list of exceptions. Report options include date type selection, date range selection or entry, data filters, and account selection. A first data filter allows Users to set up criteria to identify the period, i.e., number of days in which a predetermined number of advances or advance amounts can be entered. This first data filter allows Users to select the condition on which to filter, e.g., greater than, less than, etc. A second data filter allows users to set up criteria for the entire period (i e., the entire date range) for count and/or amount and allows Users to select the condition on which to filter, e.g. greater than, less than, etc. A third data filter allows Users to set data filters based on indicative data field values and allows Users to select the condition on which to filter, e.g. greater than, equal, less than, etc. Additional options include the ability to sort defaults to account name and provide the ability to break out ATM versus OTC (over the counter) cash advances.

The cash advance exception report contains all cash advance/ATM transactions over a set amount, e.g., $500, and is used to monitor ATM/cash advance activity. Report options include date type selection, date range selection, and account selection.

The car rental exception report identifies all card members who did not use particular rental card vendors, e.g., Avis or Hertz, for car rentals. This report can be customized using exception criteria to monitor other car rental vendors consistent with the Corporations policy.

Report options include date type selection, date range selection, charge type selection, transaction data filter items and account selection.

The travel advance report lists all ATM/cash advance transactions, providing numerous details on each transaction, including account name and number, transaction date, ATM type, network ID, ATM ID, vendor city/state, advance amount and ATM fee amount. Report options include date type selection, date range selection, charge type selection, indicative data, transaction data filter items and account selection.

The travel agency exceptions report enables Users to track travelers who are not using the Corporation's preferred travel agency. User's set the exception criteria as needed (based on the corporate policy) to report only transactions that were incurred through a different travel agency or directly from the airlines. Report options include date type selection, date range selection, charge type selection, transaction data filter items and account selection.

The ATM summary report summarizes ATM/cash advance activity by the superior account, i.e., the account to which lower level accounts are linked by virtue of the established hierarchy. Report options include date type selection, date range selection, charge type selection, transaction data filter items and account selection.

The audit detail report aids Users in identifying major spending abuse by focusing directly on “bigger ticket” charges. Report options include date type selection, date range selection, charge type selection, indicative data, transaction data filter items and account selection.

The common carrier transaction report provides a list of all common carrier charges, i.e. airline and rail, for the selected month. Report options include date type selection, date range selection, charge type selection, indicative data, transaction data filter items and account selection.

The hotel exceptions report aids Users in identifying card members who are not using specific hotels based on their corporate policy through use of the data filter/exception criteria selection. Report options include date type selection, date range selection, charge type selection, indicative data, transaction data filter items and account selection.

The hotel policy report aids Users in identifying card members who are not using specific properties in specific locations, e.g. city and state. Report options include date type selection, date range selection, charge type selection, indicative data, transaction data filter items and account selection.

The spend analysis report is used for budgeting or forecasting purposes. Users run the reports on either a calendar or fiscal year basis. A general spend analysis report includes options of date type selection, date range selection, charge type selection, indicative data, data filters, fiscal year versus calendar year, and account selection. The data filters further include:

account cities; account states; account product; account country; account zip codes; bill date; consolidated vendor chain; organization region; summary cities; summary states; summary product; summary country; summary zip codes; vendor chains; vendor country; vendor name; and vendor region.

A second spend analysis report is a trending report. Trending reports include the options of date type, date range, fiscal versus calendar year, account selection and transaction type, wherein transaction type includes, optionally, foreign and/or domestic and charges and/or credits. The trending frequency options are monthly, quarterly, semi-annually, and annually. Trending categories include total spending and specific charge type. Options include trend criteria, trend criteria fields, air/rail ticket place of issue (airline charge type only), air/rail travel agency name (airline charge type only), air/rail travel agency number (airline charge type only), consolidated vendor chain, preferred/non-preferred vendor, standard industrial classification (“SIC”) charge type, vendor chains, vendor cities, vendor city/state, vendor country, vendor region, vendor states, trending value, amount, count, and average.

The summary inquiry report includes: the report type selected from charge types, vendor chains, vendor names, consolidated vendor chains, and preferred vendors; date range selected from bill month or transaction month; starting year, wherein Users enter the starting year; calendar vs. fiscal year; report selection selected from monthly summary, monthly YTD summary, quarterly summary, quarterly YTD summary; bill type, wherein a User can select the billing type of data for inclusion in the report, such as central bill, individual bill or both; account selection; and Organization, which allows the User to request to have an initial sort by Organization, in cases where multiple organization have been selected.

The airline quarterly volume-FY option report summarizes information for each airline vendor by calendar quarter. It includes the amount, count and average for each vendor. Additional options include date type selection, date range selection, charge type selection, transaction data filter items and account selection.

The expense breakdown by organization report is a report that is similar to the expense breakdown by employee report, but summarizes the information for each Organization in the Corporation. Additional options include: date type selection; date range selection charge type selection customized to include Air, Hotel, Restaurant, Gas/Oil, Car Rental, Cash Advances and Other (e.g., all other charge types except for Late Fees, Membership Fees, Adjustments and payments); indicative data; transaction data filter items and account selection.

The international activity by country report lists all spending by country and sorted by charge type. This report includes billed amount, count and average. Additional options include date type selection, date range selection, charge type selection, transaction data filter items and account selection.

The spend by charge type summarizes transactions according to the charge type in which they are reported. This report includes charge type, billed amount, count and average. Additional options include date type selection, date range selection, charge type selection, transaction data filter items and account selection.

The volume report summarizes information by the superior account to which the transactions were billed or reported. Details included on the report include the bill/report name and number, type of transaction, account product, billed amount, count and average. Additional options include date type selection, date range selection, charge type selection, transaction data filter items and account selection.

The Expense Activity Analysis report includes a summary by Charge Type, for each individual. This analysis reports separately for foreign and domestic transactions. Additional options include date type selection, date range selection, charge type selection, transaction data filter items and account selection.

The core supplier report is a transaction report that analyzes air, car and hotel spending as well as travel agency transactions. This report displays total spending and percent of total spending. This report utilizes the consolidated vendor chain tables, vendor chains tables and preferred/non-preferred vendors tables. Additional options include date type selection, date range selection, charge type selection, Organization or Organization region selection, data filters including preferred/non-preferred vendor selection, transaction data filter items and account selection.

The employee activity report provides a list of the top x spenders for the specified period and includes the employee name, amount, count and average. Additional options include date type selection, date range selection, charge type selection, transaction data filter items and account selection.

Card Activity reports provides demographic and transactional information on specific cardholders' accounts. The reports that are included as default reports include the following.

The account inquiry report displays transactions for a specific individual account number. This information can be used, for example, to review employee activity for a specific period of time. Users are able to view the transactions by selecting either a cardmembers name or account number. The footer for the Account Inquiry contains additional cardmember information not included on other reports. This additional information includes, for example, indicative data, total cash advances, total charges, total credits, total payments, and report totals. Options include date type selection, date range selection, and last bill date information.

The account activity report recaps all individually and centrally billed transactions that appear on billing statements. This report replicates the mainframe report where it makes sense to provide transaction detail for all franchises customers. Options include date type selection, date range selection, charge type selection, indicative data field selection, transaction data filter items and account selection.

The consolidated transaction report combines travel account and individual transactions into one report by matching passenger names, from the travel agency, to the account names. Options include account number selection from dropdown list, passenger name selection which provides a list of passenger names and data filter operators to identify passenger names that will display travel account transactions that match the individual transactions selected, date range, and date type.

The airline credit report includes all airline credits for each cardmember during the period specified. The report includes airline transaction details, such as reference no., transaction date, ticket number, vendor name, and credit amount. Further options include date type selection, date range selection, charge type selection, indicative data field selection, transaction data filter items and account selection.

The disputed transaction status report includes all disputed transactions. The report includes the dispute bill date, account name and number, transaction date, billed amount, reference no, and description. Further options include date type selection, date range selection, charge type selection, indicative data field selection, transaction data filter items and account selection.

The expense breakdown by employee report includes summary information by employee, for airlines, hotel, restaurants, car rentals, gas, cash advance, and all other charges. Options include date type selection, date range selection, charge type selection, transaction data filter items and account selection.

The international spend by cardholder report displays all cardmember transactions incurred in a foreign country. This report includes account name, transaction date, vendor name, vendor cities, original charge amount, and amount billed. Further options include date type selection, date range selection, charge type selection, transaction type, transaction data filter items and account selection.

The travel activity report lists all airlines and rail transactions, sorted by ticket number. Options include date type selection, date range selection, account selection, charge type selection, and transaction data filter items.

The travel management report by individual includes account name and number, vendor name, city and state, transaction count, and amount for the date range specified as well as YTD count and amounts. Options include date type selection, date range selection, charge type selection, transaction data filter items and account selection.

The airline ticket activity report lists all airline transactions for each cardmember including vendor name, class of service, city pairs, carrier code and billed amount. Options include date type selection, date range selection, charge type selection, indicative data field selection, transaction data filter items and account selection.

The spend by charge type by traveler report provides the information to all customers to monitor how employees are spending their travel and entertainment (“T&E”) budget. The report includes account name, charge type, billed amount, count and average. Further options include date type selection, date range selection, charge type selection, indicative data field selection, transaction data filter items and account selection.

The value added tax (“VAT”) report enables the break out of value added tax for airline and rail charge types. This report allows the User to view and/or print a VAT statement. The report process assigns a statement number to each document that is generated and allows Users to print all statements, view current or next statement or enter the number of the statement they wish to view. Users have the ability to change the sort order from a very select group of sort fields. Options include date type selection; date range selection; charge type selection; sort field which includes transaction date, reference information, ticket number, passenger name and carrier; transaction data filter items and account selection.

The cards in force report provides drill down to the individual cardmember level. Options include: report type e.g., detail, summary or active card; date type; date range; account selection; data filter; account cities; account country; account organization region; account product; account states; and account zip codes. Active cards are defined as active if any transactions have occurred within the defined date range specified by the User. Payments, adjustments, member fees and late fees are excluded from calculation. Inactive cards are defined by no transactions occurring within the defined date range specified by the User. Cancelled cards are defined by the status item. The status date must then be used to see if cancelled date falls within specified date range. For new cards, this report check issue date to see if cards were issued during the specified date range. Cards in force are defined as active plus inactive minus cancelled cards.

The membership fee listing report lists all membership fee transactions for the date range specified. Options include date type selection, date range selection, charge type selection, transaction data filter items and account selection.

The account mailing list includes all active accounts, including account name, account number and address information. Options include report type, e.g., detail, exception criteria, account selection, and demographic data filter items.

The account services list report includes account name and address information, and information on the account products that cardmembers are using. Options include report type, e.g., detail, indicative data, demographic data filter items, and account selection.

The projected renewal report identifies all cardmembers whose card renewal date occurs after the month a User selects in the Data Filter. Options include report type, e.g., detail, indicative data, demographic data filter items, and account selection.

The city pair report identifies air and rail travel between cities or airports it can also be used to identify top city pairs i.e., the most frequently flown segments between cities. includes the following options: date type selection; date range selection; charge type selection-air; airport city code or expanded city name; top city pairs - based upon number of segments, i.e., travel legs,-sort defaults to segment counts; and data filters including air/rail carrier by leg, air/rail fare basis by leg, air/rail from city code, air/rail o/d destination, air/rail o/d fare, air/rail o/d fare basis, air/rail origination, and air/rail to city code.

In addition to the standard reports described above, the system and method of the present invention support User-defined reports as well. User-defined reports will enable Users to build reports through use of basic criteria and select all field/columns to be included in the report. Additionally, Users can modify their reporting options, i.e., data filters, etc., and can define the layout of the criteria, e.g., within the column/row-based format. The primary difference between standard and User-defined reports is that there are no pre-defined report fields in the User-defined report feature. The Users have the ability to select all fields which will appear on the report utilizing the User reporting options described above. The data items referred to above are categorized as account balance items, transaction items, and demographic items. The account balance items refer to, for example, account addresses, account numbers, account names, past due information, balance information, organization information (e.g., franchise information), return information, remittance information, debit information, credit information, as well as totals and summaries of these items. Transaction items refer to, for example, transaction date, bill date, vendor information, amount information, account information, ATM information, air/rail information, car rental information, hotel information, currency information, and the like. Similarly, demographic items refer to similar types of information. Other account balance, transaction, and demographic items are listed in Provisional Patent Application Serial No. 60/315,045 filed Aug. 28, 2001 which is incorporated herein by reference in its entirety.

According to an embodiment of the system and method of the current invention, Users may select from charting criteria in order to most effectively view standard and User-defined reports. Some charts are standard charts, defined by pre-defined report criteria, and others are User customized charts driven by criteria selected within an ad-hoc or prompted report. The charting requirements are listed below and each requirement is as an editable field for the User: chart types; column; bar; line; pie; column and line on 2^{nd} axis; and three dimensional (“3D” charting. The charting criteria provides the User with the ability to view a chart and the accompanying data/report. Users have the ability to copy and paste the chart as a bitmap into other applications. Data values or labels appear when placing cursor over column/line/bar/pie. Chart colors are selectable and changeable by the User. Further, Users have the ability to drill down in a chart (i.e., by charge type, vendor name, etc.).

The functionality described above is implemented through a series of network-based Web pages. For example, Users access Web pages for implementing the above-identified information through browser technology. In an embodiment of the present invention, the application of the invention is categorized into five major functional areas. The application is menu-driven and Users see the same main choices throughout the network-based Web pages. These choices include the home page, reports, the scheduler, in-box, and preferences.

The home page, appearing as “home” on the main menu bar, is the primary starting page of the application. Users have access to frequently asked questions, help regarding contacting customer support, changing passwords, and browser requirements. Through the home page, Users also have access to the main menu bar with the choices of: reports, scheduler, my in-box, preferences, and home. This menu bar is available throughout the application except when building reports.

The reports pages are accessible through “reports” on the main menu bar. As described above, embodiments of the present invention offer User selection standard reports and User-defined reports. Users have the ability to select the report, select all criteria for the report, and choose different options to run the report. All reports are organized in descriptive categories.

The scheduler pages are accessible through “scheduler” on the main menu bar. As described above, all reports that have been created by either the system manager or the User are able to be scheduled to run at a later date or run on a regular interval (daily, weekly, monthly, etc.). The scheduler lists all reports by category and allows the User to select the time frame in which to run the report. A list of all scheduled reports is kept on this page(s).

The in-box pages are accessible through “Inbox” on the main menu bar. After the User has selected a time frame to run the report and the report has run, the output will be located in “Inbox.” The User will have the option to view (e.g., in HTML format), or delete the report. The User may also have chosen an output format that can be saved to the User's local personal computer in, for example, Excel or Lotus. The report output listing has the following details: report name as defined by the User upon report creation, report states, i.e., completed or failed; date and time of report completion (assuming it was completed); report format; report deletion through hyperlink technology; and ability to view report using hyperlink technology. In the event that a report has a failed status, a hyperlink will be available for the user to delete the failed report.

The Preferences pages are accessible through “preferences” on the main menu bar. The User customizes, to the extent allowed by the application, all of the User preferences through this page(s). Among other things, Users have the ability to select from different reported currencies, set up preferred vendor chains, and customize data item fields.

According to an embodiment of the present invention, the CDW and the application are secured through multiple mechanisms. The CDW security includes limiting User access only to the data in predetermined accounts with which they are associated through the application. As discussed above, a first component of the security model is the association of each User with one or more distribution profiles. A distribution profile is a grouping of accounts that a user is allowed to see. Distribution profiles are created, and Users are assigned to one or more distribution profiles. Further, for each distribution profile, one or more top level accounts are set-up for each distribution profile. Given knowledge of the top level account, the system can then determine all of the accounts below that top level that a User should be able to see if he/she has access to the distribution profile. Finally, User access is limited by the account reporting structure. Given knowledge of which users have access to a distribution profile, and what the top level account is for that distribution profile, the system follows the tree down from that top level account to all of the top level account's subordinate accounts at all lower levels. Consequently, all queries of the CDW determine the distribution profiles a User sees, the top-level accounts for these distribution profiles, and the subordinate accounts for these top-level accounts.

At the application level, as described previously herein, each User is authenticated via a single User ID and password. User IDs and passwords comply with Corporate Information Security Office (hereinafter “CISO”) standards. The security sub-systems may include one or more, and preferably all, of the following securable components: Windows 2000 User accounts and Active Directory (hereafter “AD”); The Windows 2000 file system (hereafter “NTFS”); Microsoft Internet Information Server 5.0 (IIS); Seagate Info; and Oracle 8.i which is a virtually private database that is used in cooperation with the application security design to limit which account/transactions a User can see. This list of securable components is not intended to be exhaustive and is merely exemplary.

The server configurations also follow CISO standards, for example, the secure configuration guidelines, such as: Windows 2000 Secure Configuration Guide; Windows 2000, Internet Information Server 5.0 Secure Configuration Guide, and Unix Security Guide. In a preferred embodiment, the user interface is through the IIS web server. Because anonymous access is disabled on the web server, users must authenticate to Windows 2000 before accessing any web pages. Report templates, objects, and instances are secured through NTFS permissions. Each User has a unique Windows 2000 ID. Each User also has a corresponding Seagate Info Account and a corresponding Oracle Account. These multiple accounts are transparent to the user, but allow for the level of security contemplated by the application. This also allows the system administrator the ability to lock or suspend user accounts.

According to the preferred embodiment of the present invention, the application has four directories: an output files directory where all completed reports reside in individually accessible subdirectories; an input files directory where all report definitions reside in individually accessible subdirectories; a template files directory where all predefined, public report definitions reside and are accessible by all Users; and the IIS data directory where all scripts and HTML content resides and is accessible for reading by all Users. Operating system and administrator Users have full NTFS access authority for all four directories.

In the preferred embodiment of the present invention, the information server configuration includes home directory properties configured as follows: the content resides in a designated directory of the local computer; script source access is disabled; read access is enabled; write access is disabled; log access is enabled; directory browsing is not allowed; indexing is disabled; execute permissions are set to scripts only; and session timeout is set to e.g., 30 minutes.

The authentication methods for the web server are configured as follows: Allow Anonymous Access is Disabled; Basic Authentication is enabled; Windows NT Challenge/Response is disabled; and Digest authentication is disabled. To prevent the transmission of clear text passwords and to secure information, all transactions including the initial password exchange are encrypted with, for example, SSL (Secure Sockets Layer) 3.0. 128-bit encryption.

The system utilizes a scalable, multi-tier architecture, integration software tool in order to fully integrate and protect access to database information among multiple Users. In a particular embodiment, the system utilizes Seagate Info (hereinafter “Info”) which is configured to use integrated Windows NT/2000 security; Info uses the Active Directory account database instead of a separate internal account database. Info has internal permissions that are defined at a user, group, or object level. These permissions determine the types of operations that can be performed. By default, users inherit group permissions. This default configuration is desirable since it simplifies administration and reduces the possibility of errors. Info has a built-in group named for example, “Everyone,” that cannot be deleted. All Info Users are a member of this group. The Info servers for the application are configured so that this group has no permissions. All Users belong to an Info group with a predetermined name. This group has the following internal permissions: Add reports to desktop; Bypass Info Views when running; Create private folder; Schedule reports, queries, and programs; and Stop processing objects. The component object model (hereafter “COM”) objects built on the Seagate Info Software Development Kit (SISDK) run in the security context of the logged on user. A COM is a model for binary code developed by Microsoft. A COM object enables programmers to develop objects that can be accessed by any COM-compliant application. By way of example, 128 bit SSL Encryption is enforced, and session timeout values are configurable. Further, firewalls are configured to allow only HTTP (HyperText Transfer Protocol) and HTTPS (HTTP secure) traffic, port 80 and port 443.

The embodiments described herein are in no way intended to be limiting. One skilled in the art recognizes the many variations to the embodiments that are contemplated by the invention and fall within the scope thereof.

1. A method for administering a charge-related data presentation system for presenting charge-related data comprising:
establishing within the presentation system a first set of parameters for the presentation of charge-related data, wherein the first set of parameters includes instructions for permitting access to the presentation system and the charge-related data;
accessing the presentation system according to the first set of parameters;
establishing a second set of parameters for the presentation of charge-related data; and
establishing a third set of parameters for the reporting of charge-related data, wherein the first set of parameters is established by a first entity and the second and third sets of parameters are established by a second entity.

2. The method according to claim 1, wherein the first set of parameters includes at least one of the following group consisting of display format parameters, distribution profile parameters, region information parameters, account level description parameters, preferred vendor parameters, and consolidated vendor chain parameters.

3. The method according to claim 1, wherein the second set of parameters includes at least one of the following group consisting of display format parameters, report cycle parameters, region information parameters, preferred vendors parameters, and consolidated vendor chain parameters, wherein the second entity's establishment of the second set of parameters is limited by the first set of parameters established by the first entity.

4. The method according to claim 1, wherein the third set of parameters includes at least one of the following group consisting of report layout parameters, report type parameters, report scheduling parameters, date type parameters, date range parameters, account selection parameters, charge type parameters, data filter parameters, and cardholder group parameters.

5. The method according to claim 1, further comprising:
scheduling at least one report to run at a predetermined time selected by the second entity; and
running the at least one report at the predetermined time for the second entity, wherein the report is subject to the first, second, and third sets of parameters.

6. The method according to claim 5, wherein the predetermined time corresponds to the occurrence of an event.

7. The method according to claim 6, wherein the event is the charging of a predetermined maximum amount.

8. The method according to claim 5, wherein the at least one report is a standard report.

9. The method according to claim 5, wherein the at least one report is a user-defined report, wherein the user is the second entity.

10. The method according to claim 2, wherein the first entity is comprised of at least one sub-entity, including the second entity, wherein the first entity controls the presentation of charge-related data to the at least one sub-entity through at least the distribution profile parameter which establishes a hierarchy among the first entity and the at least one sub-entity.

11. The method according to claim 1, further comprising: establishing a network-based charge-related data presentation system, wherein the charge related data is housed in a centralized data warehouse.

12. A method for presenting charge-related data to multiple related entities comprising:
establishing a predetermined hierarchical relationship among the multiple related entities;
accessing the charge-related data within a network-based data presentation system according to the predetermined hierarchical relationship, wherein a first entity of the multiple related entities that is highest in the predetermined hierarchical relationship, determines access and presentation abilities for the remaining entities of the multiple related entities; and
presenting charge-related data to the multiple related entities in accordance with the access and presentation abilities determined by the first entity in a report.

13. The method according to claim 12, further comprising:
receiving charge-related data used in a first report at the network-based data presentation system in a first format; and
presenting the charge-related data in the first report in a second format, wherein the first format is determined by the first entity and the second format is determined by one of the remaining entities of the multiple related entities.

14. The method according to claim 13, wherein the first and second formats include at least one of the following group consisting of currency type, language type, and name.

15. The method according to claim 12, wherein the report type is selected from the following group consisting of vendor, delinquency, and compliance.

16. A method for capturing, viewing, and reporting of charge-related data over a network, comprising:
receiving first charge-related data having a first currency;
receiving second charge-related data having a second currency;
storing the first and second charge-related data in a centralized database;
receiving a request to access the centralized database and obtain a report on the first and second charge-related data;
prompting control settings for the request, wherein the control settings include: a) a currency type selection to identify the type of currency to be used for the report; and b) a preferred vendors selection to identify vendors that are preferred to be associated with the first or second charge-related data;
receiving a selection of each of the control settings; and
providing the report based on at least one of the selected control settings;
wherein the first charge-related data is derived from a charged expense incurred by a first entity, and the second charge-related data is derived from a charged expense incurred by a second entity; and
wherein the step of providing the report further comprises: a) using the selected currency type for the report when the first and second entities are different; and b) using the first or second currency for the report when the first and second entities are the same.

17. The method of claim 16, wherein the first charge-related data is derived from a charged expense incurred in a first country, and the second charge-related data is derived from a charged expense incurred in a second country.

18. The method of claim 16, wherein the control settings further include: corporation name, currency formats, language version and codes, fiscal year ending month, field item name and field size, region information, and consolidated vendor chain.

19. The method of claim 16, further comprising:
providing reporting options for the report, wherein the reporting options include: date time selection, date range selection, account selection, charge type selection, report scheduler, and spreadsheet integration, criteria page, transaction types.
